(19) United States
(12) Patent Application Publication
(10) Pub. No.: US 2015/0341697 A1
(43) Pub. Date: Nov. 26, 2015

(54) Marketing methods employing interactive media services

(71) Applicant: Karyn J. Satterfield, Greensboro, NC (US)

(72) Inventor: Karyn J. Satterfield, Greensboro, NC (US)

(21) Appl. No.: 14/717,675

(22) Filed: May 20, 2015

Related U.S. Application Data
(60) Provisional application No. 62/000,658, filed on May 20, 2014.

(51) Int. Cl. H04N 21/478; H04N 21/2543; G06F 17/30; H04N 21/4782

(52) U.S. Cl. CPC H04N 21/47815; H04N 21/4782; H04N 21/2543; G06F 17/30528; G06F 17/30554; G06F 17/30244

(57) ABSTRACT

Marketing methods employing interactive media services. A smart television application or mobile application is provided which employs Internet search infrastructure, including image recognition software to capture, analyze, and recognize an image on the screen of a smart TV, then search the Internet for text containing the title of the image, or images which share all or parts of the title of the image. The search infrastructure is controlled from a set-top device or a stand-alone wireless device, such as a smartphone. The invention is further directed to a series of business methods, processes, and results which invite the sellers, designers, and manufacturers of various articles of clothing, jewelry, and other merchandise, which appear in films and television programs, to provide data used in the population of the database.

### CROSS-REFERENCE TO RELATED APPLICATIONS

This application claims the benefit of U.S. Provisional Application No. 62/000,658, filed May 20, 2014, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to interactive sales business methods and in particular to marketing methods employing interactive media services. Smart televisions have opened a new world of data analysis and filing, based on the images of the films and television programs of the past century. Data collections such as Internet Movie Database (IMDb) and Wikipedia provide an enormous wealth of searchable data. However, acquiring the brand name and the other identifying characteristics of an article of clothing or jewelry, a sports car, or other item based on nothing more than an image seen on television presents a substantial challenge.

When a viewer sees such an item and wishes to investigate purchasing the item, finding it can be very frustrating. Fortunately, software is now available which will recognize such images. The purchaser does not need to perform an exhaustive, time-consuming, and most likely futile search for the desired item. Such questions as “Who makes that dress?”, “How much does that cost?”, or “Where can I buy that truck?” can finally be answered. Marketing methods employing interactive media services, which provide a searchable database and image recognition software to capture and analyze images from a smart television, formulates a textual search based on the image analysis, and then searches the database and the Internet for similar images and titles of those images, would resolve this problem.

### SUMMARY OF THE INVENTION

Accordingly, the invention is directed to marketing methods employing interactive media services. A smart television application or mobile application is provided which employs Internet search infrastructure, including image recognition software to capture, analyze, and recognize an image on the screen of a smart TV, then search the Internet for text containing the title of the image, or images which share all or parts of the title of the image. The search infrastructure is controlled from a set-top device or a stand-alone wireless device, such as a smartphone. The invention is further directed to a series of business methods, processes, and results which invite the sellers, designers, and manufacturers of various articles of clothing, jewelry, and other merchandise, which appear in films and television programs, to provide data used in the population of the database.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serve to explain the principles of the invention.

FIG. 1 is a front view of a smart television, displaying the television 10.

FIG. 2 is a front view of a smart television with the application installed and a top view of the pointer component, displaying the television 10, the program image 11, the selected items display 12, the performer icon 13, the entertainment icon 14, the shopping cart icon 15, the settings icon 16, and the pointer 17.

FIG. 3 is a network diagram of the system of the invention.

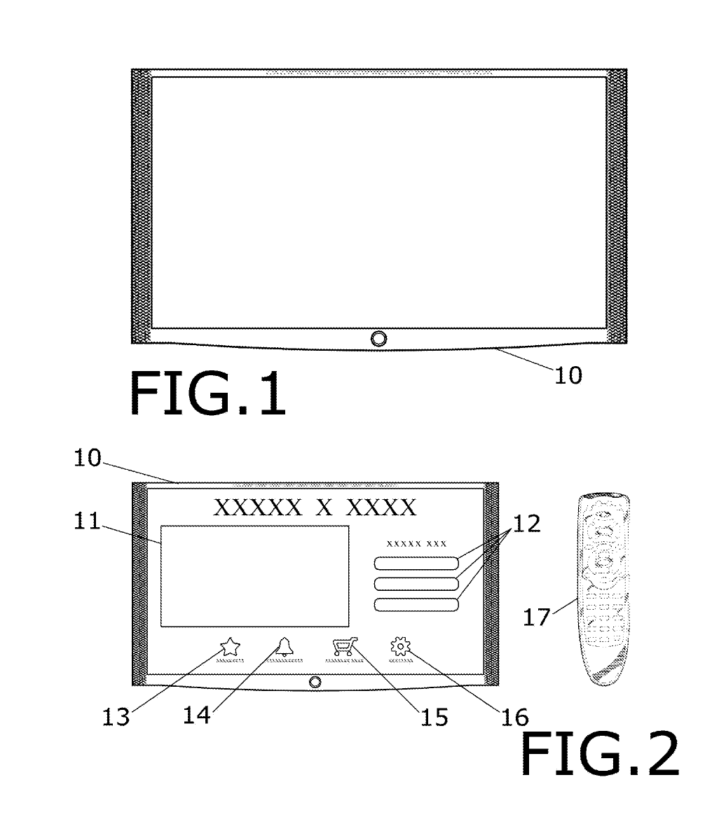

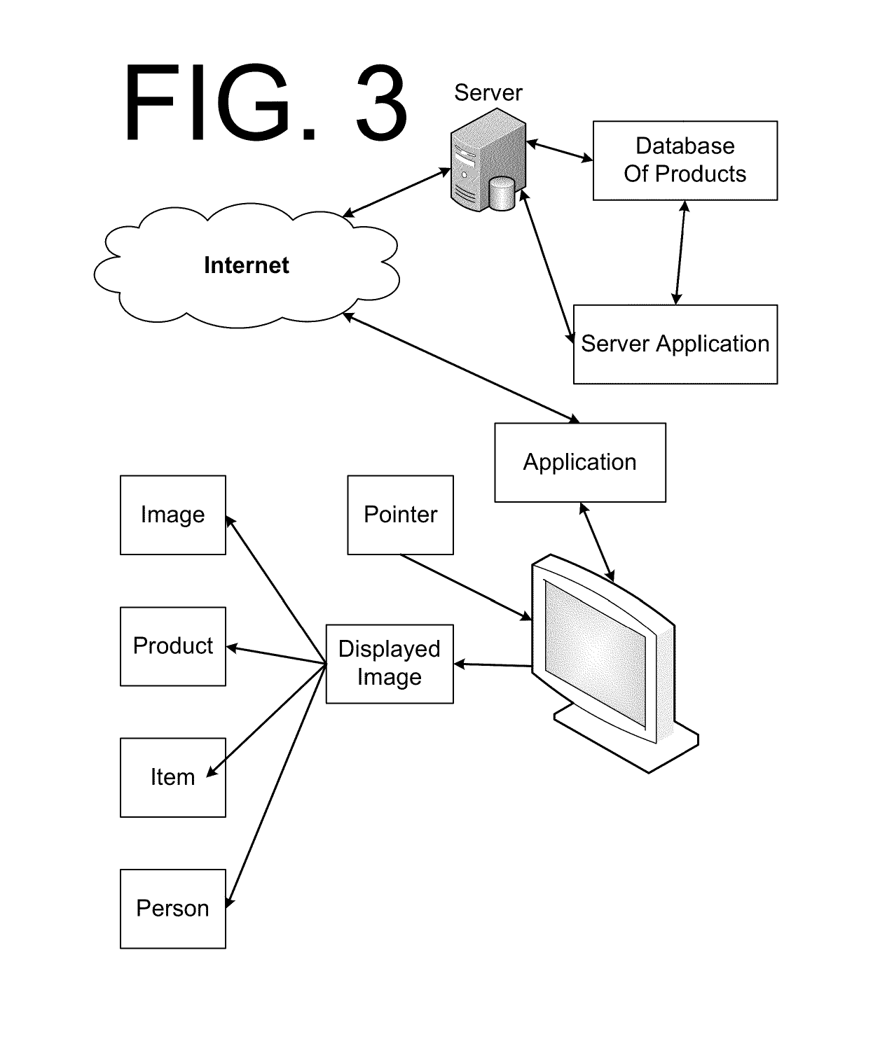

### DETAILED DESCRIPTION OF THE INVENTION

Referring now to the invention in more detail, the invention is directed to marketing systems employing interactive media services. A smart television software application or mobile software application is provided which employs Internet search infrastructure, including image recognition software to capture, analyze, and recognize an image on the screen of a smart television 10, then search the Internet for text containing the title of the image, or images which share all or parts of the title of the image. The search infrastructure may also be controlled from a set-top device or a stand-alone wireless device, such as a smartphone. The invention is further directed to a series of business methods, processes, and results which invite the sellers, designers, and manufacturers of various articles of clothing, jewelry, and other merchandise, which appear in films and television programs, to provide data used in the population of the database.

Components of the first exemplary embodiment include the user's smart television 10; a set-top device connected to the user's smart TV via a High Definition Multimedia Interface (HDMI) cable, operating via a wireless router; and a pointer 17. The pointer 17 incorporates all of the functions of a cable television remote control and the remote control of a DVD or Blu-Ray™ player, and additionally may be used to select and capture an image on the television screen, and operate the application. The search function identifies salient characteristics of the captured image, and then correlates the captured image with other images on the Internet sharing the same salient characteristics, and with images and text which share elements of the title of the captured image.

The application displays a program image 11, offset slightly to the left on the screen of the smart TV 10. To the right of the program image 11, the application will generate a working list of selected items in a selected items display 12. The search function continuously explores the Internet and an image recognition database of product images and related data, which is operated on a website by the provider of the application, to provide additional data related to the selected items. Below the program image 11 and the selected items display 12, four icons are displayed: the performer icon 13, the entertainment icon 14, the shopping cart icon 15, and the settings icon 16.

The user is able to pause TV programming and select an object shown in the image. The system then presents a section of the image to a search engine as a search query, and consults the image recognition database, thereby converting the image into a textual search query. Alternatively, after identifying the object, the system could provide predetermined relevant links for the detected object, such as an actor's Internet Movie Database (IMDb) record, or the website for the designer or manufacturer of the clothing article selected. The search includes data services such as Wikipedia and IMDb, and image hosting services such as Flickr and Photobucket. The search function then delivers search result pages to the user via the television screen of the smart television, or the visual display of a user's electronic device, such as a laptop computer or smartphone.

The sellers, designers, and manufacturers of clothing, shoes, vehicles, and other products which appear in popular films and television programs are invited to provide images and data related to the items. Sellers, designers, and manufacturers which provide images and data become clients of the provider of the application. These images and data are then used to populate the image recognition database, and their placement may be done free of charge by the provider, or for a fee or royalty paid to the provider by each client. The royalty may be calculated by the provider as a percentage of product sales obtained by the client via the application. Preferably, the clients would also enjoy obtaining a form of advertisement for their products any time the application is used to view their products. Thus, the provider of the application also provides a marketing service to its clients.

Because smart televisions are popular to display in millions of homes, each client could reach large numbers of potential customers that it normally would not reach. The applications and related components could be marketed to users, and the marketing service could be marketed to clients, through websites, television, radio, print periodicals, telephone contacts, and mail order.

To use the first exemplary embodiment, the user connects the set-top device to the smart television 10 using the HDMI cable provided, and synchronizes the set-top device with the Internet using a wireless router. The user then downloads and installs the related application on the smart television 10 or the user's electronic device, such as a smartphone or tablet computer. The user then synchronizes the pointer 17 with the smart television 10 and any cable or satellite television system connected to the smart television 10.

The user then activates the application, which displays the film or television program being viewed in the program image 11, and may select and capture an image in the program image 11, by pointing and clicking with the pointer 17. The user may use the pointer 17 to pause the film or television program to conduct the search. The set-top device analyzes the captured image and conducts an Internet search. The items selected, and relevant search result pages, are displayed in the selected items display 12 on the television screen, or on the user's electronic device.

The user may consult data regarding an actor or actress wearing or using the selected item by pointing and clicking with the pointer 17 on the performer icon 13. The user may also consult data regarding the film or television program being displayed by pointing and clicking on the entertainment icon 14. The selected items may be dragged and dropped into the shopping cart icon 15 to create a list of items for purchase, and the user may subsequently double-click on the shopping cart icon 15 to enter credit card and shipping information to complete the user's purchase. The settings icon 16 may be used to change the desired performance settings of the application, and pre-load credit card and shipping information.

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A system for marketing employing interactive media services, comprising:
(a) a television;
(b) said television being a smart television;
(c) a pointer;
(d) said pointer being calibrated to said smart television such that said pointer is configured for selecting an image, product, person, or item by pointing said pointer at the screen.
(e) a software application;
(f) said software application being stored on and run by said smart television;
(g) a server;
(h) said software application being in electronic communication with said server via an electronic data network;
(i) said server being electronically connected with a database;
(i) said database containing images and data of consumer products;
(k) said software application being configured for the user opening said application and using said pointer to select an image, product, or person displayed on said smart television, and said application, via said server, performing a search of said database for similar images.

2. The system of claim 1 wherein said server provides a server software application that is configured for searching said database and the internet using a selected image displayed on said smart television as a query.

3. The system of claim 2 wherein said application provides a home screen comprising an image display, a performer icon, an entertainment icon, a shopping cart icon, a settings icon, and a results display.

4. The system of claim 3 wherein said image display shows the captured image from said smart television.

5. The system of claim 3 wherein said performer icon performs said search on an actor or actress selected using said pointer.

6. The system of claim 3 wherein said entertainment icon performs said search for information pertaining to the television program or movie being watched by a user.

7. The system of claim 3 wherein users use said pointer to drag a result from said results display to said shopping cart icon; said application charging said result to a credit card and shipping to a shipping address.

8. The system of claim 3 wherein said settings icon opens a settings menu wherein a user selects preferences and enters billing and shipping information.

9. The system of claim 3 wherein said results display lists the results of said search.

10. The system of claim 2 wherein said application being installed on a mobile electronic device such that said search of a captured image may be performed on said mobile electronic device.

11. A system for marketing employing interactive media services, comprising:
(a) a television;
(b) a set-top box;
(c) a pointer;
(d) said pointer being calibrated to said set-top box such that said pointer is configured for selecting an image, product, person, or item by pointing said pointer at said television;
(e) a software application
(f) said software application being stored on and run by said set-top box;
(g) a server;
(h) said software application being in electronic communication with said server via an electronic data network;
(i) said server being electronically connected with a database;
(j) said database containing images and data of consumer products;
(k) said software application being configured for the user opening said application and using said pointer to select an image, product, or person displayed on said television, and said application, via said server, performs a search of said database for similar images.

12. The system of claim 11 wherein said server provides a server software application that is configured for searching said database and the internet using a selected imaged displayed on said television as a query.

13. The system of claim 12 wherein said application includes a home screen comprising an image display, a performer icon, an entertainment icon, a shopping cart icon, a settings icon, and a results display.

14. The system of claim 13 wherein said image display shows a captured image from said television.

15. The system of claim 13 wherein said performer icon performs said search based on a person shown in a captured image from said television.

16. The system of claim 13 wherein said entertainment icon performs said search for information pertaining to the television program or movie being displayed in a captured image.

17. The system of claim 13 wherein users use said pointer to drag a result from said results display to said shopping cart icon; said application charging said result to a credit card and shipping to a shipping address.

18. The system of claim 13 wherein said settings icon opens a settings menu wherein a user selects preferences and enters billing and shipping information.

19. The system of claim 13 wherein said results display lists the results of said search.

20. The system of claim 12 wherein said application being installed on a mobile electronic device such that said search of a captured image may be performed on said mobile electronic device.
